(19) United States
(12) Patent Application Publication
(10) Pub. No.: US 2009/0138190 A1
(43) Pub. Date: May 28, 2009

(54) System and Method of Providing Traffic Data to a Mobile Device

(75) Inventors: Victor KULIK, Claremont, CA (US); Anatole M. LOKSHIN, Huntington Beach, CA (US); Ailin MAO, Chino Hills, CA (US); Karunanidhi UPPARAPALLI, Diamond Bar, CA (US)

Correspondence Address: GREENBERG TRAURIG, LLP (SV3), IP DOCKETING, 2450 COLORADO AVENUE SUITE 400E, SANTA MONICA, CA, 90404, US

(73) Assignee: MAGELLAN NAVIGATION, INC., Santa Clara, CA (US)

(21) Appl. No.: 11/945,211

(22) Filed: Nov. 26, 2007

(51) Int. Cl. G08G 1/01; G08G 1/052

(52) U.S. Cl. 701/119; 701/117

(57) ABSTRACT

A traffic data server wirelessly provides relevant traffic details to mobile subscribers at minimal data transmission, while supplying enough data for re-routing and detouring. Two-way wireless data connectivity allowing the server to know what data the mobile device has received in the past, allows the server to send, to a mobile device, only data that is necessary, i.e. updates to mobile users that are small data sets comprising the change in the previously received data to the current data.

### BACKGROUND

The present disclosure relates, generally, to a road navigation system and particularly to an improved system and method of providing traffic data to a mobile device.

Traffic information services are now widely available in North America and Europe and are establishing themselves on other continents. The goal is to alert motorists about accidents and road hazards affecting road traffic flow in an area. The traffic information services are usually provided, in the United States of America (USA), through the Traffic Message Channel (TMC), with the messages periodically broadcast to subscribers by the FM Radio Data System (RDS). The RDS has usual limitations of all broadcast services—since the data is broadcast to all subscribers in a certain region, such as a metropolitan region in the USA, the data has to cover the whole regional road network thus cannot be very detailed due to the limited bandwidth of the air channel. Since more mobile devices are now capable of two-way wireless data connectivity to data networks through wireless modems, it is an opportunity for each mobile customer to receive, from a server, customized sets of the traffic data, relevant to their current location, route and/or destination, therefore, providing traffic data on demand to customers in a timely efficient manner without customers waiting for the RDS broadcasts.

However, receiving the traffic data through a data network via a two-way wireless data connection, an example of such a data network is the General Packet Radio Service (GPRS), comes at a cost—firstly, the customer has to pay for each kilobyte of the data received, and secondly, due to the limited bandwidth of the data modems and networks, receiving long messages can take a significant amount of time or could become all but impossible in the case of poor signal strength. Therefore it becomes extremely important to optimize the traffic data flow to keep the data volume in the user request and system response to a minimal.

In some previous navigation systems, the following method of minimizing the GPRS traffic data has been employed. The mobile device plans a route after a user selects a destination, then it requests traffic data only along the route. The limitation of such an approach is that the route is not optimal because it is generated without considering the traffic conditions on the planned route or other alternative routes, and if the user encounters traffic congestion and needs a detour, or drives off the route for any reason, the system is unable to account for the traffic conditions on the surrounding roads and to efficiently re-route or detour to non-congested roads because only data for the route has been provided. Therefore a need exists for a system and method to overcome these limitations.

### SUMMARY

A system and method of providing traffic data to mobile devices with two-way wireless data connectivity is disclosed. A traffic data server wirelessly provides relevant traffic details to mobile subscribers at minimal data transmission, while supplying enough data for re-routing and detouring.

Two-way wireless data connectivity allows the server to know what data the mobile device has received in the past. Notifying the server of previously received data allows the server to send to a mobile device only data that is necessary, i.e. updates to mobile users that are small data sets comprising the change in the previously received data to the current data.

The traffic data may be sub-divided into regions by geographical locations, and the information may be sent to the user for one or more regions near the user's current location and/or destination.

Furthermore, the data prepared by the server preferably may be data pulled from a TMC data source, averaged and the resolution may be reduced thus, reducing data set volume and increasing the time between necessitated updates.

In one embodiment, a method for providing traffic data to a mobile device is disclosed. The method comprises set operations of: determining a set of comprehensive traffic data for a geographical region at a first time; determining a current set of comprehensive traffic data for the geographical region at a second time; calculating a current differential set of traffic data from a difference between the current set and previous set of comprehensive traffic data; storing the current differential set of traffic data. The set operations are then repeated for a subsequent current set of comprehensive traffic data at a next time. Upon receiving an update request from the mobile device, an update of traffic data to update an existing set of traffic data stored in the mobile device, for the geographical region. The update set of traffic data includes one or more differential sets of traffic data or a set of comprehensive traffic data.

In one instance, the smaller of the one or more differential sets of traffic data and the set of comprehensive traffic data is provided to the mobile device.

In another instance, the method may further comprise sending a list of active road sensor locations to the mobile device and the list of active road sensor locations may be periodically updated to the mobile device.

In another instance, the method may further comprise storing additional sets of comprehensive traffic data for the geographical region at periodic intervals. The method may also store a differential traffic data set to be made available to the mobile device at one or more subsequent times between the storing of each comprehensive data set at periodic intervals.

In another instance, the method may further comprise repeating the set operations for another geographical region.

In another instance, each comprehensive sets may be sub-divided into different road categories; a category of at least one comprehensive set for highways and a category of at least one comprehensive set for local streets for calculating at least one separate differential set for the highways and at least one separate differential set for local streets and wherein each comprehensive set is sub-divided into a separate comprehensive set for different road categories

In another instance, the method may further comprising identifying the existing set of traffic data stored on the mobile device and determine whether the existing set of traffic data matches one set of the comprehensive traffic data. The method may also comprise, in response to identifying a match, provide the mobile device with one or more of the differential data sets to update the existing set of traffic data stored on the mobile device.

In another instance, the method may further update of traffic data includes one or more composite differential sets of traffic data.

In another instance, each comprehensive data set may comprise a road speed identifier for one or more road locations wherein the identifier represents a range of speed values. Each identifier may corresponds to a speed range larger than a TMC standard of 10 km/h. The identifiers may corresponds to a 30 km/h speed range or the identifier may correspond to a 10 km/h. The different speed ranges would be represented by different colors on the display of the mobile device.

In another instance, the method may further comprise identifying one or more geographical regions for which the traffic data is to be provided to the mobile device, based on location data received from the mobile device; and determining whether the one or more geographical regions are different from the geographical region.

In another instance, the method may further comprise, providing a set comprehensive traffic data to the mobile device that corresponds to the current geographical region in response to the update request from the mobile device, if the current geographical region is different from the geographical region.

In another instance, the current geographical region is at least one of a geographical region the mobile device is currently residing in or a geographical region of interest to a user of the mobile device.

In another embodiment, a method for providing traffic data to a mobile device is disclosed. The method comprise set operations of: defining a set of geographical regions; determining a set of comprehensive traffic data for each region in a plurality of geographical regions at a first time; determining a current set of comprehensive traffic data for the plurality of geographical regions at a second time; calculating current differential sets of traffic data from a difference between the current set and the previous set of comprehensive traffic data and storing the current differential sets of traffic data. The set operations are then repeated for a subsequent current set of comprehensive traffic data at a next time. Upon receiving from a mobile device a traffic data update request for a geographical region, the region including an identifier identifying an existing set of traffic data stored in the mobile device; determining, from the identifier, a first subset, from the set of geographical regions, for which traffic data is requested; determining a set of traffic data to be provided to the mobile device from the first subset of set of geographical regions; and transmitting the determined set of traffic data to the mobile device.

In one instance, the method may further comprise determining a second subset of the set of geographical regions including an existing geographical region, corresponding to the existing set of traffic data stored on the mobile device.

In another instance, each comprehensive sets may be sub-divided into different road categories; a category of at least one comprehensive set for highways and a category of at least one comprehensive set for local streets for calculating at least one separate differential set for the highways and at least one separate differential set for local streets and wherein each comprehensive set is sub-divided into a separate comprehensive set for different road categories

In another instance, the update of traffic data may include one or more composite differential sets of traffic data.

In another instance, the method may further comprise sending a list of active road sensor locations to the mobile device.

In another instance, the list may be periodically updated to the mobile device.

In another instance, each comprehensive data set may comprise a road speed identifier for one or more road locations wherein the identifier represents a range of speed values. Each of the identifiers may correspond to a 30 km/h speed range or they may correspond to a 10 km/h range. The different speed ranges may be represented by different colors on the display of the mobile device.

In another embodiment, a system for providing traffic data to a mobile device obtained from a traffic data source is disclosed. The system comprises a server utilizing a computer readable medium for encoding a computer program of instructions for executing a computer process of steps including: determining a set of comprehensive traffic data for at least one geographical region at a first time; determining a current set of comprehensive traffic data for the at least one geographical region at a second time; calculating a current differential set of traffic data from a difference between the current set and the first set of comprehensive traffic data; storing the current differential set of traffic data. The set operations are then repeated for a subsequent current set of comprehensive traffic data at a next time. The system also comprises one or more mobile devices. Each mobile device is in communication with the server for receiving an update set of traffic data to update an existing set of traffic data stored in the mobile device, for the first at least one geographical region. The update set of traffic data comprises one or more of the differential data sets of traffic data or one of the sets of comprehensive traffic data.

In one instance, the smaller of the one or more differential traffic data sets and the set of comprehensive traffic data is provided to the mobile device.

### DRAWINGS

This disclosure is illustrated by way of example and not limitation in the figures of the accompanying drawings in which like references indicate similar elements.

FIG. 1 illustrates an overall system, in accordance with the present disclosure, that includes a server module that communicates with a mobile device, in accordance with one embodiment.

FIG. 2 is a block diagram of a mobile device in accordance with one embodiment.

FIG. 3 shows an exemplary table of sets of comprehensive traffic data and differential traffic data held for a plurality of times and regions, in accordance with one embodiment.

FIG. 4 illustrates a map of a geographical region defined by a plurality of sub-regions, in accordance with one embodiment.

FIG. 5 shows process flow operations for providing a mobile device with traffic data for a region, in accordance with one embodiment.

FIG. 6 is process flow diagram of a process for storing comprehensive traffic data and differential traffic data at multiple times and regions, in accordance with one embodiment.

FIG. 7 illustrates an example screenshot of a navigation unit display displaying a route to a destination on a map, in accordance with one embodiment.

FIG. 8 shows example icons, in accordance with one embodiment.

FIG. 9 shows example screenshots, in accordance with one embodiment, that provide information about traffic events occurring along a route.

FIG. 10 shows an exemplary screenshot, in accordance with one embodiment, displaying an alert indicating traffic events along the route.

FIG. 11 shows exemplary screenshots, in accordance with one embodiment, displaying a list of directions to a destination on a map, the map includes indicators of traffic incidents and/or events along the route.

FIG. 12 shows an exemplary set of signs or icons that may be displayed to represent roadside events, hazards, and/or warnings, in accordance with one embodiment of this disclosure.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure may be, but not necessarily are, references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present disclosure presents a system and method designed to provide a user of a mobile 2-way connected device with up-to-date traffic details while, at the same time, reducing the wireless data volume sent to mobile device without affecting data quality and information content.

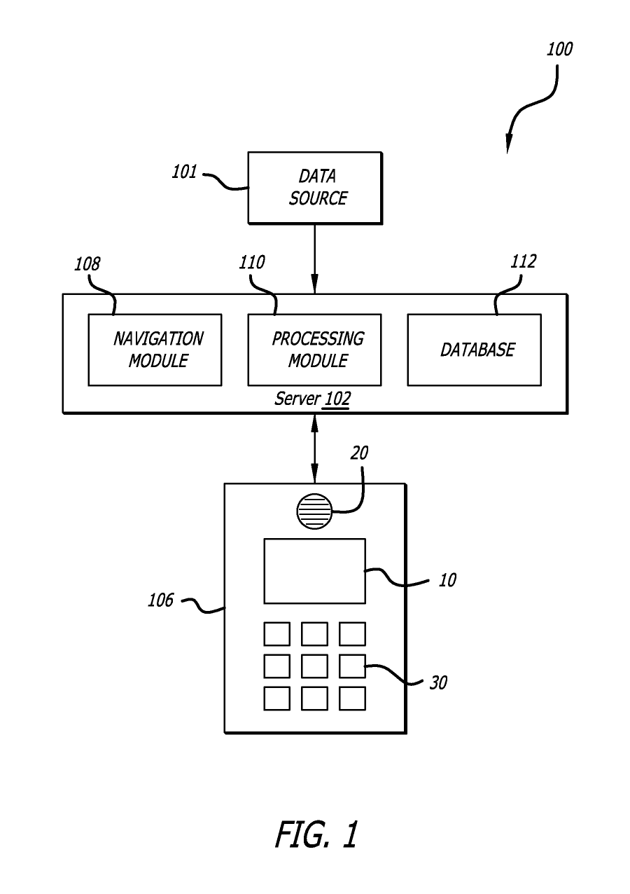

In accordance with the present disclosure, an exemplary system 100 providing traffic data to a mobile device 106 is shown in FIG. 1. The exemplary system 100 includes a mobile device 106 including input and output capabilities. The mobile device 106 includes a display 10, such as a high resolution LCD or flat panel display and may include an audio speaker 20. The mobile device 106 includes an input device 30, which may include a plurality of buttons and a directional keypad, or a touch screen, or alternatively may include a mouse, keyboard, keypad, stylus, microphone and/or may receive input via speech recognition. Alternatively, the display 10 could also be a touch screen display.

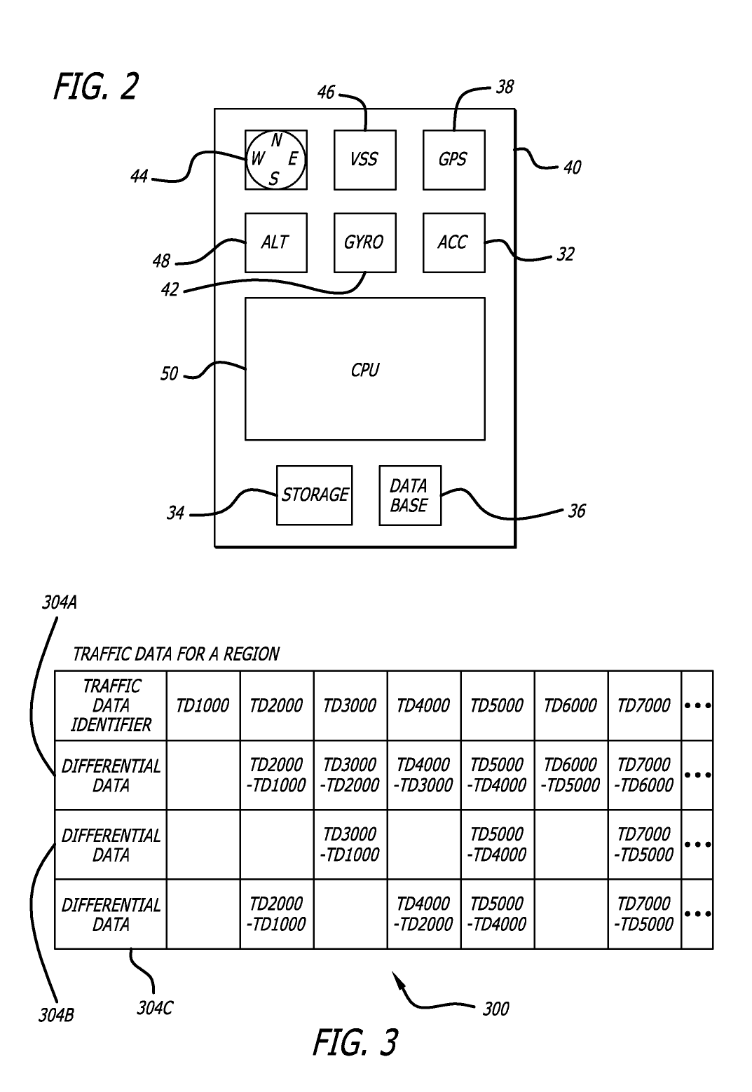

The mobile device 106 preferably includes a computer module 40, shown in FIG. 2. The computer module 40 includes a CPU 50 and storage device 34 connected to the CPU 50. The storage device 34 may include a hard drive, CD ROM, DVD, RAM, ROM or other optically readable storage, magnetic storage or solid state storage media. The storage device 34 contains a database 36 including a map of all the roads in the area to be traveled by a vehicle as well as the locations of potential destinations, such as addresses, hotels, restaurants, or previously held locations. The software for the CPU 50, including the graphical user interface, route guidance, operating system, position-determining software, etc may also be held in the storage device 34 or alternatively may be stored in ROM, RAM or flash memory.

The mobile device 106 may include navigation sensors, such as a GPS receiver 38 and an inertial sensor, which is preferably a multi-axis accelerometer 32. The mobile device 106 may additionally include one or more gyros 42, a compass 44, a wheel speed sensor 46 and altimeter 48, all connected to the CPU 50. Such position and motion determining devices (as well as others) are well known and are commercially available. The mobile device 106 determines the position of the vehicle relative to the map database 36, i.e. relative positions on road segments and intersections (“nodes”). The mobile device 106 also determines the current location of the vehicle in terms of latitude and longitude. Utilizing any of a variety of known techniques, the position of the vehicle relative to the map database 36 and/or in terms of latitude and longitude is preferably determined at least in part based upon the motion signals from the multi-axis accelerometer 32. In addition, the current local time and date may be determined from the GPS signals received by the GPS unit 38.

Generally, the CPU 50 and position and motion determining devices determine the position of the vehicle relative to the database 36 of roads. Further, as is known in the art of navigation systems, the user may select a destination relative to the database 36 of roads utilizing the input device 30 and the display 10. The mobile device 106 then determines and displays a recommended route directing the driver of a vehicle to a desired destination. The mobile device 106 may display turn-by-turn instructions on display 10 and give corresponding audible instructions from the audio speaker 20 and monitor progress along the route, thus guiding the driver to the desired destination.

The mobile device 106 may include Mobile Data Service (e.g., General Packet Radio Service, or (GPRS)). Thus, data transfer to the mobile device may be charged on a per unit (e.g., per megabyte) of transferred data basis. GPRS may be utilized for services such as WAP access, SMS, and MMS, as well as Internet communication services such as email and web access.

The mobile device 106 communications with a server 102 wirelessly. The server 102 utilizes a processing module 110, a server database 112 and a data source 101. In contrast to traditional methods of mass broadcasting traffic data to passive mobile devices, the mobile device 106 of the present disclosure has two-way wireless data connectivity to the server 102 and requests traffic data from server 102. This requesting operation may be done at the user's request by inputting a destination or mobile device 106 may be programmed to periodically request current updates of the traffic “picture,” in its vicinity, at predetermined times.

In one embodiment, the present disclosure provides a method of preparing and storing data from a data source 101 to be sent to the mobile device 106. The server 102 periodically receives or pulls traffic data from the data source 101 for an entire service area, such as a country or continent. Examples of such data sources are Navteq and TeleAtlas.

The original data received or pulled from data source 101 will usually be complied from raw traffic sensor data, derived from multiple sensor located on the roads. The data will be averaged between multiple sensors, and across the original data refresh rate (usually 1 minute), and interpolated to the pre-defined TMC traffic locations.

Upon reception of data from data source 101, the processing module 110, in server 102, will calculate an output data set to be delivered to a mobile device 106. Until more current data is received by server 102 from data source 101, this output data set is held in a storage area or in a cache and ready to be forwarded to the mobile device 106 upon request. When more current data is received by server 102, a new output data set is calculated by the processing module 110 and this new output data set replaces the previous output set held in the cache.

In order to reduce the data volume of the output data set that may be transmitted to a mobile device 106, the processing module 110 calculates two output data sets from the data source 101 data received. One set, is a set of comprehensive traffic data and another set is a differential set being the difference between the comprehensive set, as it was last calculated, and the current traffic data calculated. The smaller of the set of comprehensive traffic data and the differential sets of traffic data will be the set transmitted to the mobile device 106.

The comprehensive traffic data set may include, for example, all traffic information within a 5 square-kilometer region or an entire country at a predetermined time. The comprehensive traffic data set would be a complete “snap shot” of the traffic situation, including all incidences and speed information, at the time the comprehensive set was calculated. The comprehensive traffic data set will be, usually, different from the original traffic pulled from the data source server 101, due to the necessity of the mobile data preconditioning, volume optimization and formatting, but it will be, basically, a traffic “snapshot,” without traffic history involved. The differential set, on the other hand, will be the difference between the current traffic data and the most recent past comprehensive data set. Alternatively, each differential set may be the difference between the current data and one of the most recent comprehensive sets.

The comprehensive traffic data sets will be calculated as often as the differential updates on the server 102. Whether a comprehensive set or differential update is sent to the mobile device 106 will depend on the availability and age of the traffic data previously stored on the mobile device 106, and on the relative size of the comprehensive and differential updates. Receiving the comprehensive or differential update will bring the mobile device 106 up to date with the current traffic data.

The differential updates include a difference in the traffic “snap shot” obtained from two different instants in time for a particular region and thus only include the change(s) or update(s) to the previously calculated data set sent to mobile device 106. Therefore, the differential update sets are determined by the server 102 as the difference between two comprehensive data sets with different time stamps or from two different instances in time, one set current and the previous current set.

As an example, during a thirty minute period, there may be one comprehensive data set made available to the mobile device 106 by server 102 along with fifteen differential updates. When mobile device 106 requests data, only the data needed to update the device data needs to be transmitted to the device. Thus, if the mobile device 106 requests data at 3:11 PM, and the mobile device 106 was last updated at 3:00 PM, then the differential updates for 3:02, 3:04, 3:06, 3:08 and 3:10 PM would be sent. If there was no change in the traffic data during any of the time periods, then the differential update for that period would simply be an empty set.

The comprehensive traffic data set may preferably be sent to mobile device 106 in the following situations: If mobile device 106 had no data stored therein, if the held data set(s) are too old, or if no differential updates are available for transmission from server 102. In any event, however, the smaller of the one or more differential sets of traffic data and the set of comprehensive traffic data is provided to the mobile device.

The differential updates, held for transmission, in server 102 may have a limit or maximum age because old updates become inefficient. As an example, let's denote max update age in the Output data set as MAX_AGE (minutes). If mobile device 106 has traffic data older than MAX_AGE held therein, the comprehensive set of traffic data will be sent, because such an old update may be unavailable.

In one embodiment, server 102 may receive original comprehensive traffic data once a minute from data source 101. Server 102 would then convert this data into the comprehensive set of traffic data into an output format for mobile device 106, and put it into an Intermediate traffic buffer containing MAX_AGE last consecutive comprehensive traffic sets (from the MAX_AGE minutes old till the current). Then server 102 calculates the differential updates for the Output set as follows.

Update Current-1, for mobile device 106 that has traffic 1 minute old. Such an update can be calculated from 2 comprehensive sets−the current set and previous (1 min old) set, and will include new traffic events relative to the previous comprehensive set (that are active now and were not active a minute ago), and cancelled events (that were active 1 min ago and are no longer active)

Update Current-2, for mobile device 106 with held traffic data 2 minutes old. It can be calculated from 2 comprehensive traffic sets: the current set and the 2 minute old set.

Update Current-MAX_AGE, for mobile device 106 with held traffic data MAX_AGE minutes old. It can be calculated from 2 comprehensive traffic sets: the current set and the MAX_AGE minute old set.

In one embodiment, the traffic update rate from server 102 to mobile device 106 may vary. The traffic can be, in principle, sent to the unit as often as every minute (or whatever the data source 101 update rate is). In such a case, all mobile device's 106 will be receiving Update Current-1 (for the data 1 minute old). Older updates, for the data N>1 minutes old, may be sent to mobile device 106 with older traffic held therein. It may happen either because the device has been shut down for several minutes, or when the device has been continuously powered, but connection to the server was lost for a few minutes. Providing a differential update (rather than the bigger comprehensive traffic) to a mobile device 106 whose unit was shut down for a few minutes (less than MAX_AGE), would only be possible if the traffic data in mobile device 106 is saved in mobile device 106 on power down. Otherwise the server 102 has to send the latest comprehensive data set to mobile device 106.

In accordance with embodiments of the present disclosure, server 102 may determine which data set and/or update(s) to send mobile device 106 by way of an electronic tag or identifier sent to the server 102 along with the update request. The electronic tag or identifier would be encoded to advise the server 102 of the time and region of the previous update, enabling server 102 to provide proper subsequent update(s).

Being able to identify the existing set of traffic data, server 102 will determine if the last data set received by mobile device 106 is current. If the data set last received by mobile device 106 is identified by server 102 to be held therein (e.g. is current), server 102 will not send an update. If the data set identified by server 102 is different than the data set held therein (e.g. is not current), server 102 will send either a comprehensive set or a differential update, as determined from the last data set received by mobile device 106.

As an example, if the existing set of traffic data was held for t=t0 and the traffic data was requested for t=t3, the differential update D (t1−t0) held at t=t1, the differential update D (t2−t1) held at t=t2, and the differential update D (t3−t2) held at t=t3 may be provided to the mobile device 106 such that the mobile device 106 may create a current “picture” of traffic data at t=t3. In other embodiments, differential updates may be held at varying intervals. For example, the differential update D (t2−t0) and D(t3−t2) may be held and sent to the mobile device 106 instead. In other embodiments of a system in accordance with the present disclosure, the differential updates could be obtained and held more frequently, such as during rush hours, or less frequently when traffic changes less rapidly. An example of the latter may be between 2 and 3 am.

Alternatively, the server 102 may pre-compute and store composite differential updates referenced to a predetermined comprehensive data set, e.g. D(t1−t0), D(t2−t0), D(t3−t0). In such a case, only composite update D(t3−t0) may be sent to the mobile device 106. Therefore, a composite update data set includes data for one or more time instances where one or more differential sets of data were determined and is essentially an update that is one or more combined differential sets. This may further reduce the amount of data that would need to be sent to the mobile device 106, even in the cases when mobile device 106 missed one or more updates.

FIG. 3 shows an exemplary table 300, illustrating sets of comprehensive traffic data 302 and differential traffic data 304A-C, in one embodiment of the present disclosure. The data sets, in table 300, are held for a plurality of time instants (t1-t7) for a particular region. Table 300 is an example of how the traffic data may be held in the database 112. The time variables t1-t7 represent time instants at which traffic data is obtained and recorded. The time variables may be represented in relative format (e.g., t2=t1+1 minute), or in absolute format (e.g., t2=22 hours 35 seconds). The representation of the time variables and the intervals between the time variables may vary as applicable without deviating from the teachings of this disclosure.

Preferably, both comprehensive traffic data sets and differential updates are held in database 112 of server 102 to, for example, identify the existing set of traffic data held on mobile device 106 and provide mobile device 106 with current traffic data for a region of interest.

The differential sets of traffic data may be computed and/or held at predetermined intervals in time. For example, in row 304A, differential updates of traffic data are determined and held at times t2, t3, t4, t5, t6, and t7. Similarly, differential updates of traffic data may be determined and held at larger time intervals as illustrated in rows 304B and 304C. In one instance, the time interval at which differential and comprehensive data sets are held may vary depending on storage capacity of the database 112. In some instances, differential updates of traffic data may be calculated and held more frequently during rush hours when traffic flow is higher. The frequency (e.g., time intervals) at which the comprehensive traffic set and differential updates are held may be adjusted automatically or manually depending on the time/date and the region, without deviating from the scope of this disclosure.

When a request for traffic information is received from a mobile device 106, server 102 identifies, from the request, the existing set of traffic data held by the mobile device 106. A tag or identifier may include a time stamp and/or one or more geographical markers for identifying the regions for which the mobile device 106 has existing traffic data. Traffic information of each region may be tracked by a data table such as the one illustrated in FIG. 3. For example, if the mobile device 106 requests an update for traffic data for a 5 square-kilometer region including 1^{st} St. and 5^{th} Ave. at time t6, server 102 discovers that the mobile device 106 has an existing data from time t4 and sends differential updates (TD5000-TD4000) and (TD6000-TD5000) to mobile device 106 to bring it current. The mobile device 106, using the existing traffic data held therein plus the differential updates provided by server 102 can then cumulatively compile a current comprehensive set of traffic data for time t6.

If, for example, the identifier indicates that the differential update for the existing traffic data held on the mobile device 106 is no longer held in database 112 (e.g., for time t<t1 in FIG. 3), the server 102 may provide a comprehensive set of traffic data TD6000 to the mobile device 106.

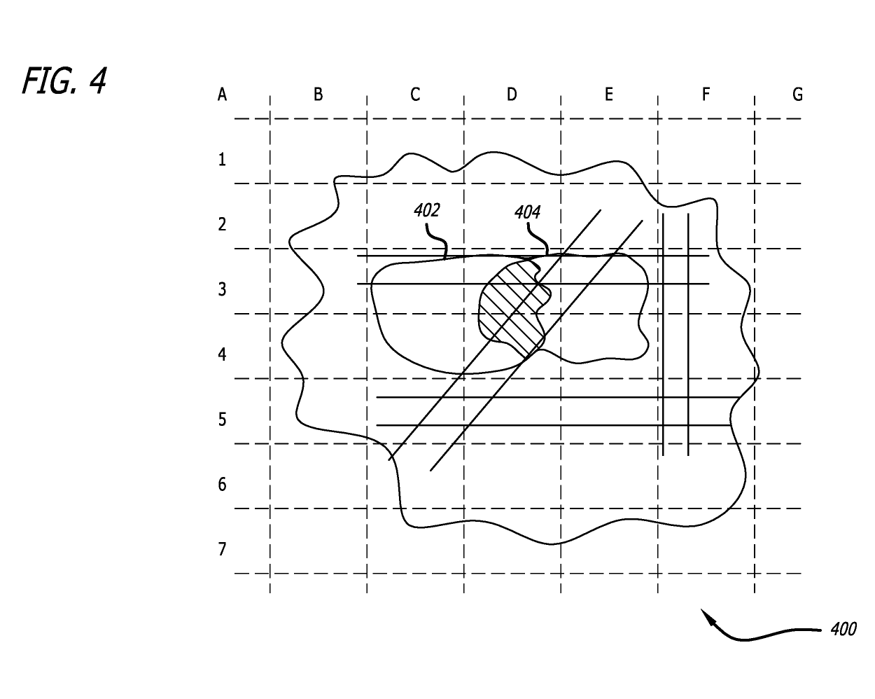

FIG. 4 shows a region 400 for one exemplary embodiment, on a map defined by a plurality of sub-regions. Region 400 is divided into smaller sub-regions by dotted lines forming a grid defined by the horizontal rows (1-7) and the vertical columns (A-G). Thus, traffic information may be calculated and held for each sub-region (e.g., sub-regions A2, C4, etc.). The sub-regions of FIG. 4 are illustrated to be of substantially the same sizes, however, it should be noted that the sub-regions may be of varying sizes. For example, region 302 would include sub-regions 3C, 3D, D4, and C4. It should be noted that while the rectangular shape and equal size of the sub-regions would be most convenient for spatial indexing, in other embodiments the sub-regions may be of varying sizes and shapes, not necessarily rectangular.

By calculating traffic data for smaller sub-regions, server 102 may then send mobile device 106 smaller datasets specific to the current sub-region(s) in which mobile device 106 may be located or may be in route to, as opposed to sending a much larger all area data set, as used in traditional methods that may include data for an entire continent, country, state or county. For example, if the mobile device 106 holds an existing set of traffic data for sub-region 402 (e.g., 3C, 3D, 4C, and 4D) and requests a current set of traffic data for the sub-region 404 (e.g., 3D, 3E, 4D, and 4E), traffic information for sub-regions 3C and 4C (e.g., the common regions as illustrated with diagonal lines) no longer need to be sent. For sub-regions 3E and 4E, since the mobile device does not have traffic data held for these regions, comprehensive data sets held for these regions may also be provided to the mobile device 106.

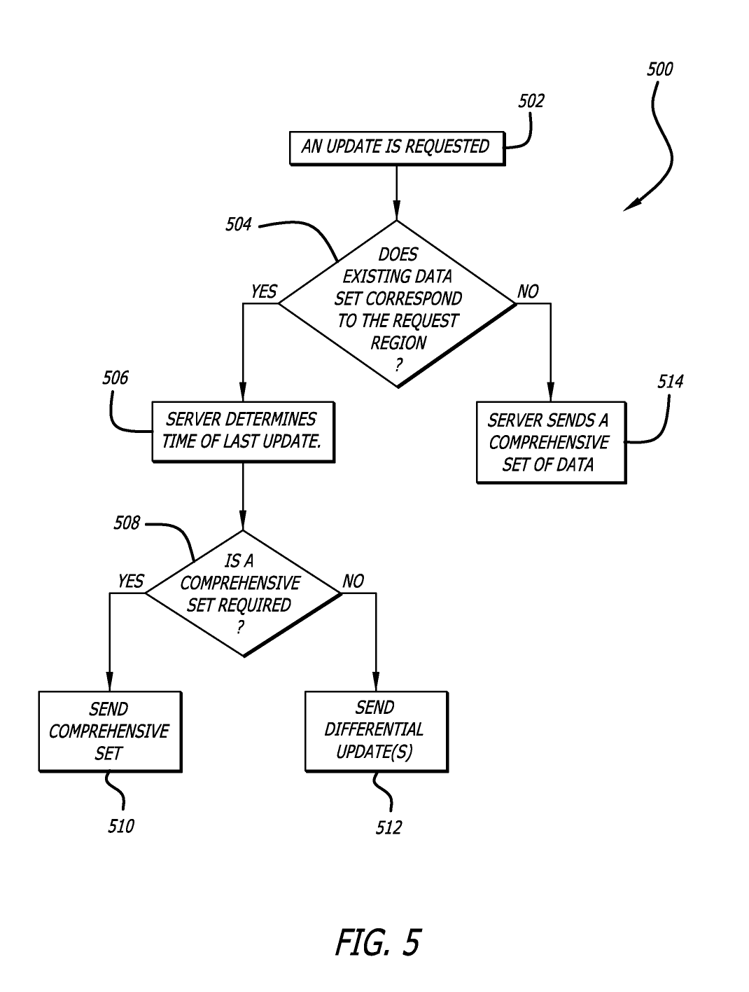

In one embodiment, process flow operation 500 providing traffic data to mobile device 106 for a particular region is shown in FIG. 5.

Operational flow begins in initialization operation 502, where an update request is sent from mobile device 106 to the server 102. Control then transfers to decision operation 504, where the server 102 receives the request and proceeds to determine if the existing data set (the last update received by mobile device 106) is from the region mobile device 106 is now requesting an update for. If the answer determined in decision operation 504 is ‘Yes,’ control transfers to operation 506. If the answer determined in decision operation 504 is ‘No,’ control is transferred to operation 514, where the server 102 sends a comprehensive set of data for the requested region because mobile device 106 is new to that region and has, therefore, not received any data for the same, concluding this branch of process flow operation 500.

If, however, the answer in decision operation 504 was ‘Yes,’ then in operation 506, the server 102 determines the last time mobile device 106 was updated by the tag or identifier sent along with the update request. Once the server 102 has identified the time mobile device 106 was last updated, it can determine if it requires a comprehensive set of data or one or more differential updates. Control then transfers to decision operation 508.

In decision operation 508, server 102 determines if a comprehensive set is required. If the data last received by mobile device 106 is older than the oldest differential update held by server 102, ‘Yes,’ a comprehensive set is required and control transfers to operation 510. If the data last received by mobile device 106 is not older than the oldest differential update, the answer determined in decision operation 508 is ‘No’ and one or more differential updates, i.e. the number of updates required to bring the mobile device 106 current, are sent to mobile device 106 updating the same in operation 512.

In operation 510 a comprehensive set of traffic data is sent to mobile device 106, updating the same and concluding this branch of process flow operations 500.

Referring back to FIG. 3, in some instances, the size of the region for which traffic data from table 300 is recorded and held may be determined by server 102, based on the density of the traffic data. For example, traffic data is potentially higher on local streets than freeways because of the high density of local streets. Thus a larger region may be tracked along freeways.

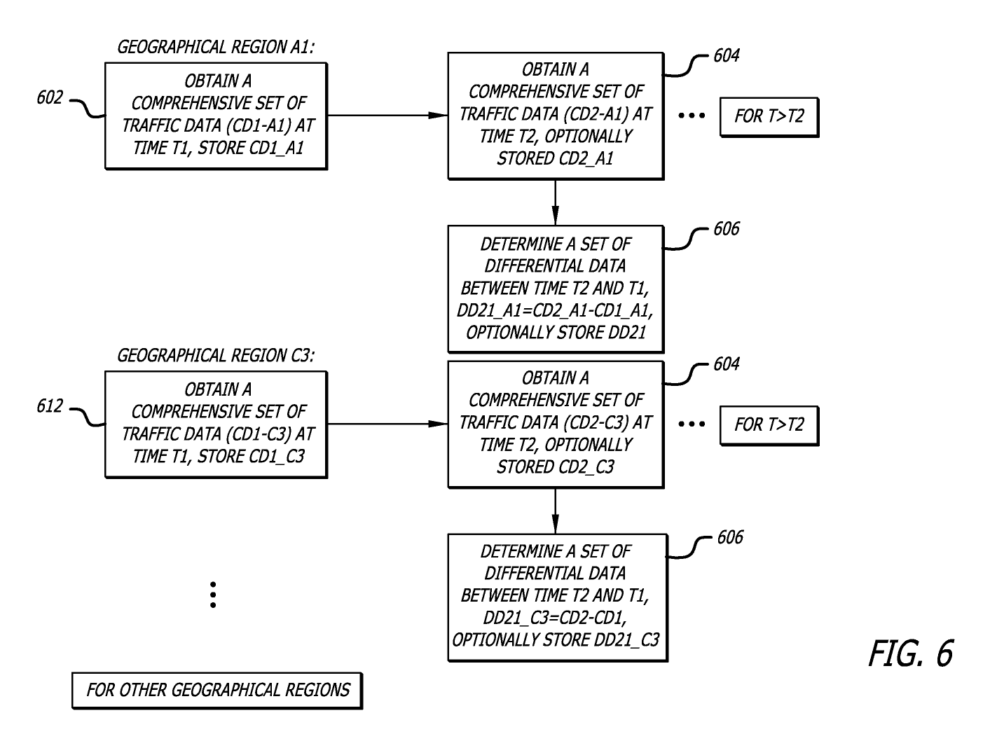

If the tag or identifier indicates that the last update received by the mobile device 106 was for a different region than the currently requested data, a comprehensive data set for the currently requested region would be sent. FIG. 6 shows a diagrammatic view of a process for storing comprehensive traffic data and differential updates at multiple times and for multiple regions. Traffic data may also be individually recorded and held for different sub-regions (such as the sub-regions shown in FIG. 4). That is, a separate traffic database 112 may be used for each sub-region. For example, for sub-region A1, in operation 602, a comprehensive set of traffic data (CD1_A1) is obtained at time t1 and the comprehensive set of traffic data (CD1_A1) may be held. In operation 604, a comprehensive set of traffic data (CD2_A1) may be obtained at time t2 and optionally held. In operation 606, a differential update between time t2 and t1 is calculated (DD21_A1=CD2_A1−CD1_A1) and is optionally held. The same operation may be repeated for t>t3 for maintaining the currency of the traffic data, at the region A1.

Similarly for sub-region C3, operation 612, a comprehensive set of traffic data (CD1_C3) is obtained at time t1. In operation 614, a comprehensive set of traffic data (CD2_C3) may be obtained at time t2 and optionally held. In process 616, a differential update between time t2 and t1 is calculated (DD21_C3=CD2_C3−CD1_C3) and is optionally held. Similarly, the operation may be repeated for t>t3, for maintaining currency of the traffic data, for the region C3.

The operations described above may be applied to each sub-region. Thus, when a request for traffic data is received by server 102, the traffic data for the relevant sub-regions may be identified. Based on this identification, a comprehensive set or differential update of traffic data for each region may be transmitted to mobile device 106.

Different traffic events have different effects and duration based on their distance from the requesting mobile device 106. For example, a user of mobile device 106 driving on the freeway may be affected by traffic events 50 kilometers away and would, therefore, be interested in traffic events at that distance. Conversely, events on the surrounding local streets at a 50 kilometer distance are highly unlikely to affect the user of mobile device 106. Therefore, in one embodiment of the present disclosure, the output data sets may be subdivided into a road category for freeway network data, a category for highway network data and a category for local street network data. This would divide the comprehensive data sets into separate road categories: comprehensive data sets for the freeways, comprehensive data sets for the highways, and comprehensive data sets for the local streets for calculating separate differential sets for the freeways, highways and local streets, enabling a user of the mobile device 106 to receive updates of freeway traffic information covering a wider geographical area than an area covered by the updates of the local street traffic information. This may be achieved, for example, by sending freeway network updates for more than one geographical region and only sending a single geographical region for the local street network where each road category has an equal size, such as K square degrees. Alternatively, the size of the geographical regions may vary among the freeway network, the highway network, and the local street network. For example, 1 square degree size for the freeway network, 0.5 square degrees for the highway network, and 0.25 square degrees for the local street network. In one instance, each road category may have a dedicated database. Therefore, a separate database may be maintained for the freeway network, the highway network, and the local street network for storing and calculating the different comprehensive and differential data sets. In another instance, all the road categories may be maintained by a single database. Therefore, the aforementioned categories may further reduce the data volume provided to the mobile device 106.

A data filtering method may also further reduce the data volume being transmitted to a mobile device 106 is disclosed. Since the data from data source 101 is generally sent every minute, the data tends to be noisy. Filtering the traffic data across a period longer than a minute on server 102 before sending the data set(s) to the mobile device 106 may make the data more reliable by averaging out abnormalities and thus, decreasing the number of data transmissions required to bring mobile device 106 up-to-date.

In one embodiment, an additional method of data filtering to further reduce the data volume is disclosed. This data filtering method reduces the data resolution related to vehicle speed because too high a resolution may be useless, sometimes even harmful, due to data noise. Therefore, by representing the data by different colors, highlighting the roads on display 10 of mobile device 106, and, for example, using 3 colors, such as yellow, orange, and red would lower the data resolution, making it more reliable and less susceptible to data noise. Using three colors would combine the speed values on any roadway into 3 groups, rather than 7 as is currently utilized with the TMC broadcasts and may lower the overall data volume being sent to the mobile device 106. By reducing the represented speed resolution, traffic events change less frequently, therefore, further reduce the volume of the comprehensive data sets and differential updates sent to the mobile device 106 because there would be less changes to report. Preferably, this speed resolution reduction would be performed on server 102, prior to sending the data.

For example, the speed may have to change by 20-30 km/h for a data change to occur, whereas in some of the prior art systems that have a 10 km/h resolution (for example TMC), a 10 km/h change would result in a change to the data, thus, making the data more volatile and requiring more frequent updates.

In an exemplary instance, the resolution reduction may further reduce the data volume due to the way traffic events are coded in the TMC standard, in accordance with the present disclosure. When the TMC format is used to send data, and the same event (such as a congestion speed 10 km/h) is applicable to N adjacent locations (road segments), it is sufficient to send one event code (i.e. “red”) for the first location, and extend this parameter to N locations, notifying mobile device 106 that the same event is occurring on N adjacent locations. When the output speed resolution is reduced from, for example, 10 km/h to 20-30 km/h, the same event code will pertain to more locations thus, the same number of congested road segments will be represented by a smaller number of events.

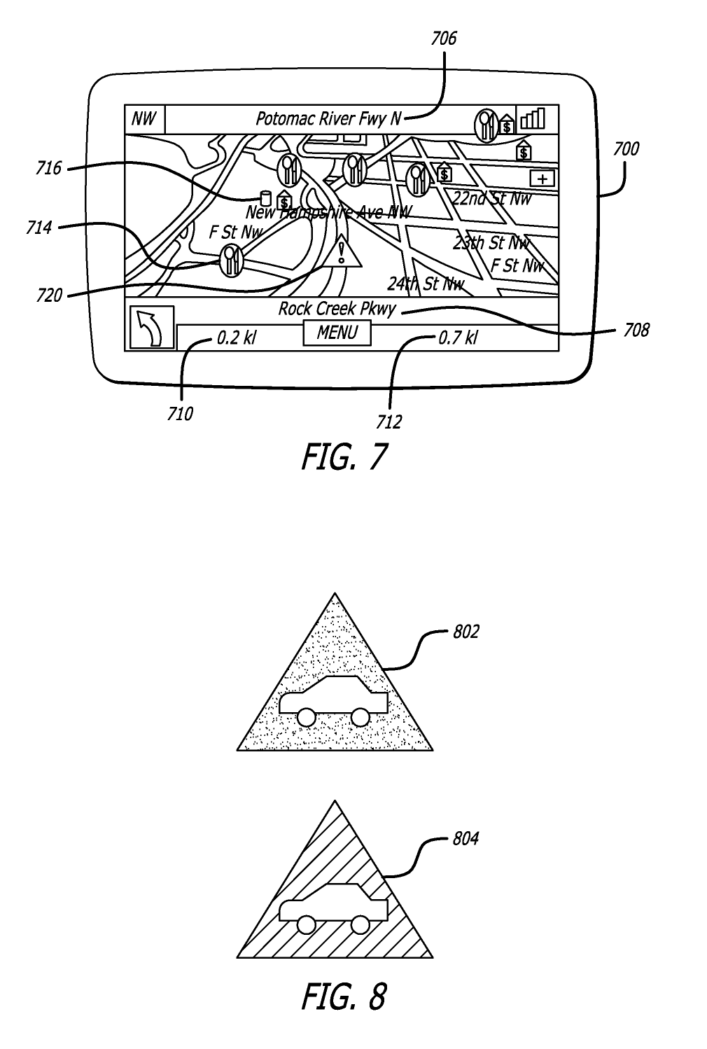

In one embodiment, FIG. 7 illustrates an exemplary screenshot 700 of a display showing a route to a destination on a map. Once the user has selected to map a route to a selected destination or point of interest, a map illustrating the directions may be displayed on screen 10 of the mobile device 106. As illustrated, the map may be displayed from the perspective of the user and oriented according to the direction of travel. The map may be displayed in 2D or 3D.

In one embodiment, the route that the mobile device 106 is currently taking may be highlighted on the screen. Alternative routes may be highlighted in different colors. In some instances, the icons and menus displayed on the screen 10 are interactive, for example, if an icon for a restaurant is clicked, additional information about the particular restaurant may be presented on the screen 10 and directions to the restaurant may be displayed when the icon is clicked (e.g., selected).

Additionally, the street name that the mobile device 106 is currently traveling on may be displayed 706 (“Potomac River Fwy N.”). In one instance, the name of the street or freeway to turn on to from the current street is displayed 708 (“Rock Creek Pkwy”) in the bottom of the screen 10 and the distance to travel before reaching the next street to turn on 710 (“0.2 km”), may be displayed for example. The remaining distance to be traveled to reach the destination may be displayed 712 (“0.7 km”) on the bottom right corner of the screen 10. In one instance, the position 712 on the screen 10 may be tapped to toggle between a display indicating the remaining distance to reach the destination and the approximate remaining time to reach the destination.

FIG. 8 shows icons 802 and 804, in one embodiment, for indicating whether the mobile device 106 is receiving traffic data. The icons 802 or 804 may be displayed when the mobile device 106 is able to receive traffic information. Traffic information may include traffic incidents such as, but not limited to road hazards, traffic density and slow traffic areas. In one instance, icon 802 is displayed when there are no traffic incidents along a route or within a predetermined distance (e.g., 15 square-kilometers) of the current location of the mobile device 106. In one instance, icon 804 may be displayed if there are one or more traffic incidents or other hazardous situations on a planned route, or within a predetermined distance of the current position of mobile device 106.

The traffic icons 802 or 804 may be selected to access traffic information for regions of interest, such as the traffic situation along a current route of the mobile device 106, or the traffic situation within a predetermined distance of the current location of mobile device 106. In one instance, upon selection, traffic icons 802 or 804 may display a list of traffic events, as shown in FIG. 8.

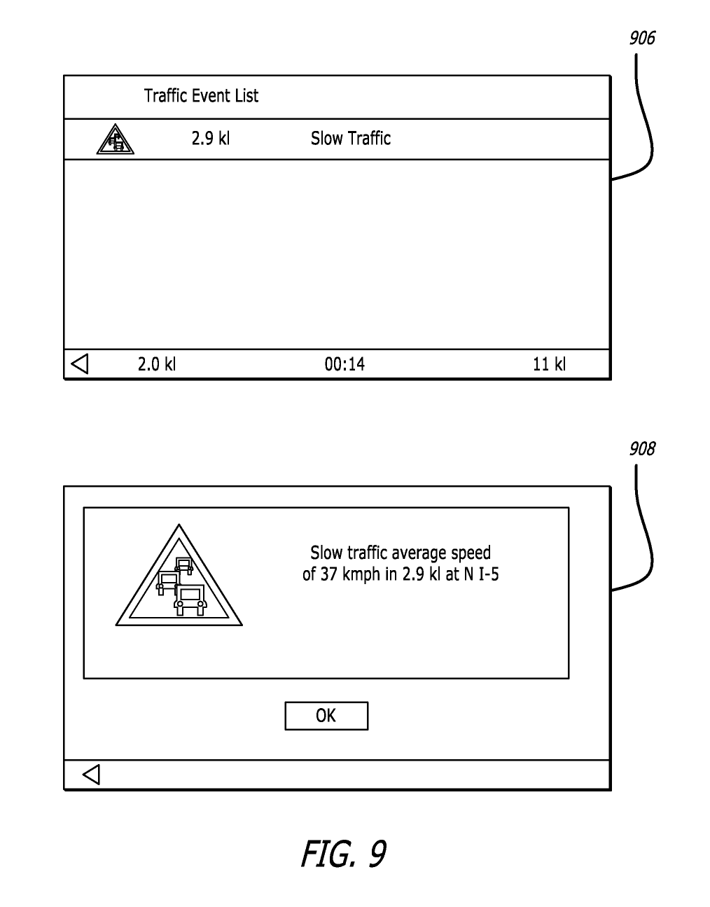

FIG. 9 illustrates example screenshots 906 and 908, in one embodiment, providing information about traffic events occurring along a route. Screenshot 906 displayed on the screen 10 of the mobile device 106 provides a list of traffic incidents along a planned route or within a predetermined distance of the location of the mobile device 106. Additional details about traffic events may be accessed by selecting the event 906 from the event list. In one instance, the traffic incidents or other events are listed in the order of distance from the current location of the mobile device 106. For example, as illustrated in FIG. 9, the event list indicates that there is slow traffic located approximately 2.9 kilometers from the current location of the mobile device 106. Additional information such as the average speed and the precise address of the location of the slow traffic 908 may be provided.

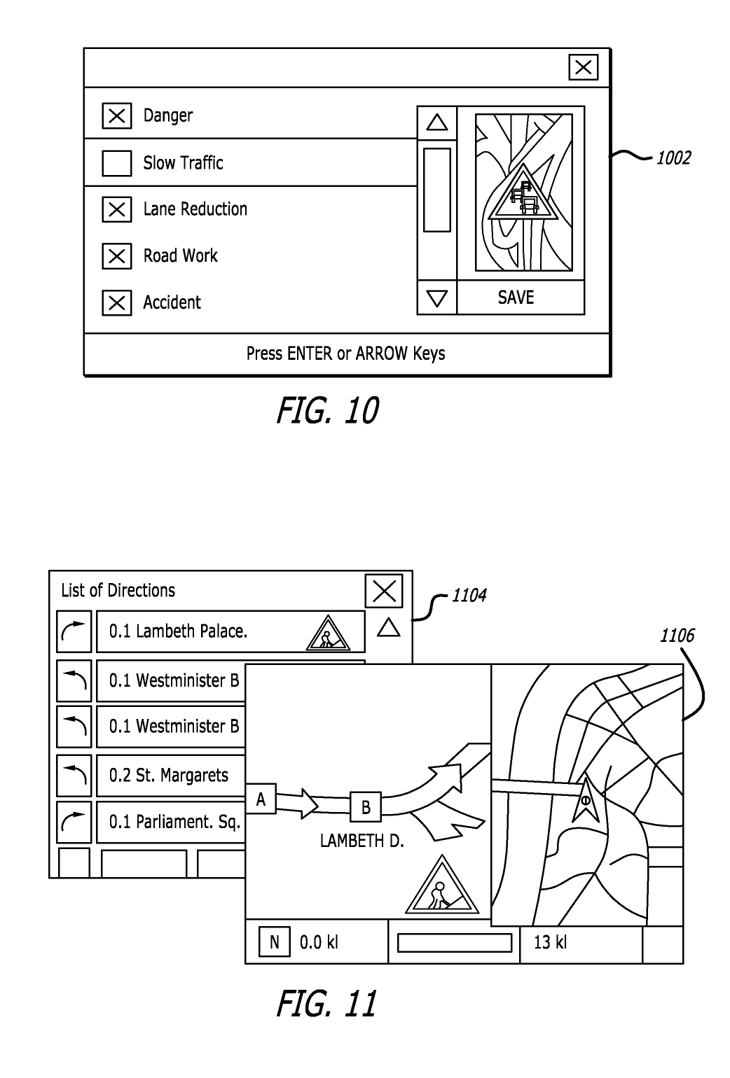

FIG. 10 illustrates an example screenshot 1002 displaying an alert indicating traffic events along a route, in one embodiment. The screen 10 allows the user to select the types of incidents and/or other events to be displayed on the map as they occur. As shown in FIG. 10, the tracked traffic incidents displayed include: ‘danger’, ‘slow traffic’, ‘lane reduction’, ‘roadwork’, and/or ‘accident’. The user may select one or more of these traffic events to be displayed on a map on screen 10 when they occur. In FIG. 10, the user has selected to view occurrences of slow traffic along the route to the destination. In one instance, a slow traffic indicator may be displayed as a triangular sign, and displayed approximately where the trouble spot is occurring. In another instance, the slow traffic indicator sign may be selected by the user for obtaining additional information about the traffic situation.

FIG. 11 shows screenshots 1104 and 1106 displaying a list of directions to a destination on a map, the map may include indicators of traffic incidents and/or events along the route. The interface screenshot 1104 provides a list of directions to a destination. The list of directions may, in some instances, include the distance (e.g., in number of kilometers) to travel on each street or freeway. In one instance, each entry of the list of directions may include a traffic condition indicator. As illustrated in FIG. 11, a ‘road work’ indicator is displayed next to the entry ‘Lambeth Palace’, indicating that there is roadwork occurring on this street. Screenshot 1106 displays a map of the route to reach a destination. In one instance, the map also displays traffic warning indicators, such as the ‘road work’ sign near Lambeth Palace.

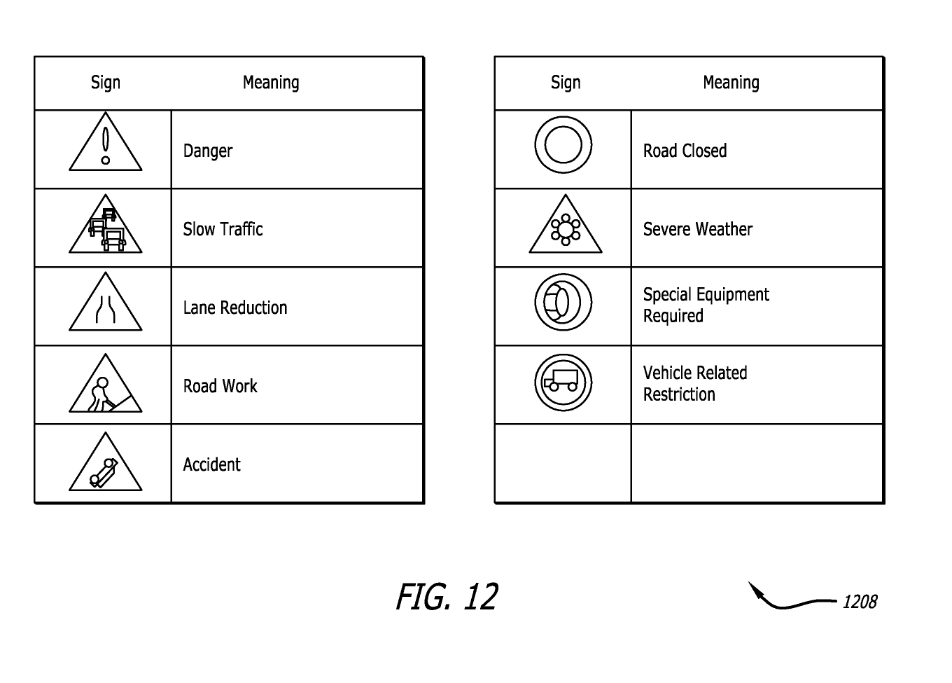

FIG. 12 shows table 1208 illustrating a plurality of signs to be displayed on screen 10 to represent roadside events, hazards, and/or warnings.

While the apparatus and method have been described in terms of what are presently considered to be the most practical and preferred embodiments, it is to be understood that the disclosure need not be limited to the disclosed embodiments. For example, letting the mobile device 106 know a list of active road sensor locations for each region for which data is actually being provided for via traffic sensors on the roads. If the mobile device 106 has this list of the active locations (which would be much smaller than the hard coded total list of the locations), then the assumption that no congestion data means there is no traffic in that region will be absolutely correct. This can be achieved by coloring the roads on the display 10 of the mobile device 106, where there are no road sensors and thus is no data, a different color than the speed value colors, white for example, indicating that there is no data along this road.

Since new road sensors are not installed too often, the new active location list will have to be sent to the mobile device 106 rarely, like once a month or a once every few months. Since the active list size for one region will be relatively small (currently less than 1000 active locations for each region, and each location is coded by just 2 bytes), sending the list will not be costly. The benefit, however, may be a data volume reduction due to not sending the non-congested data at all.

The algorithm may be as follows. When the mobile device 106 sends a request for the traffic for a certain region, it may include, in the request, not just the previous traffic data tag or identifier in support of the differential updates, but also an active location list tag or identifier (or version number, or time stamp) for this region. If the server 102 finds there is a newer list available for that region, that list will be sent to the mobile device 106 along with the traffic data. The list will have to be stored within the mobile device 106, so that it may be used after power cycle.

Most users of such a mobile device 106 usually travel within one metropolitan region, so the new list will have to be update just every month, for example. If the user crosses the region boundaries, however, the list for the new regions will be required. An easy way of avoiding re-sending the list every time the mobile device 106 goes from, for example, LA to San-Diego or back, is simply allocating enough memory to store the active locations list for several (or all) metropolitan regions. Then once the list has been received, it can be re-used in the mobile device 106 until the next list version for a region becomes available on the server 102.

This disclosure is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method for providing traffic data to a mobile device, the method comprising:
a) determining a set of comprehensive traffic data for a geographical region at a first time;
b) determining a current set of comprehensive traffic data for the geographical region at a second time;
c) calculating a current differential set of traffic data from a difference between the current set and previous set of comprehensive traffic data;
d) storing the current differential set of traffic data;
e) repeating operations a, b, c and d for a subsequent current set of comprehensive traffic data operations at a next time; and
f) providing to a mobile device, upon receiving an update request from the mobile device, an update of traffic data to update an existing set of traffic data stored in the mobile device, for the geographical region, wherein the update set of traffic data includes one or more differential sets of traffic data or a set of comprehensive traffic data.

2. The method of claim 1, wherein the smaller of the one or more differential sets of traffic data and the set of comprehensive traffic data is provided to the mobile device.

3. The method of claim 1, further comprising sending a list of active road sensor locations to the mobile device.

4. The method of claim 3, wherein the list is periodically updated to the mobile device.

5. The method of claim 1, further comprising storing additional sets of comprehensive traffic data for the geographical region at periodic intervals.

6. The method of claim 1, further comprising repeating steps a through e for another geographical region.

7. The method of claim 1, wherein the update set of traffic data is sub-divided into a separate update for different road categories.

8. The method of claim 5, further comprising storing a differential traffic data set to be made available to the mobile device at one or more subsequent times between the storing of each comprehensive data set at periodic intervals.

9. The method of claim 1, further comprising identifying the existing set of traffic data stored on the mobile device and determining whether the existing set of traffic data matches one set of the comprehensive traffic data.

10. The method of claim 9, further comprising, in response to identifying a match, providing to the mobile device with one or more of the sets of differential data to update the existing set of traffic data stored on the mobile device.

11. The method of claim 1, wherein the update of traffic data includes one or more composite differential sets of traffic data.

12. The method of claim 1, wherein each comprehensive data set comprises a road speed identifier for one or more road locations and wherein the identifier represents a range of speed values.

13. The method of claim 12, wherein each of the identifiers corresponds to a speed range larger than a TMC standard of 10 km/h.

14. The method of claim 1, wherein each identifier corresponds to a 10 kilometer per hour range.

15. The method of claim 12, wherein each of the identifiers corresponds to a 30 kilometer per hour speed range.

16. The method of claim 12, wherein the range of speed values are represented by different colors on a display of a mobile device.

17. The method of claim 1, further comprising:
identifying one or more geographical regions for which the traffic data is to be provided to the mobile device, based on location data received from the mobile device; and
determining whether the one or more geographical regions are different from the geographical region.

18. The method of claim 17, further comprising, providing a set comprehensive traffic data to the mobile device that corresponds to the current geographical region in response to the update request from the mobile device, if the current geographical region is different from the geographical region.

19. The method of claim 17, wherein the current geographical region is at least one of a geographical region the mobile device is currently residing in or a geographical region of interest to a user of the mobile device.

20. A method, for providing traffic data to a mobile device, the method comprising:
a) defining a set of geographical regions;
b) determining a set of comprehensive traffic data for each region in a plurality of geographical regions at a first time;
c) determining a current set of comprehensive traffic data for the plurality of geographical regions at a second time;
d) calculating current differential sets of traffic data from a difference between the current set and the previous set of comprehensive traffic data;
e) storing the current differential sets of traffic data;
f) repeating the operations b, c, d and e for subsequent current sets of comprehensive traffic data operations at a next time;
g) receiving from a mobile device a traffic data update request for a geographical region, the region including an identifier identifying an existing set of traffic data stored in the mobile device;
h) determining, from the identifier, a first subset, from the set of geographical regions, for which traffic data is requested;
i) determining a set of traffic data to be provided to the mobile device from the first subset of set of geographical regions; and
j) transmitting the determined set of traffic data to the mobile device.

21. The method of claim 20, further comprising determining a second subset of the set of geographical regions including an existing geographical region, corresponding to the existing set of traffic data stored on the mobile device.

22. The method of claim 20, wherein the update set of traffic data is sub-divided into a separate update for different road categories.

23. The method of claim 20, wherein the update of traffic data includes one or more composite differential sets of traffic data.

24. The method of claim 20, further comprising sending a list of active road sensor locations to the mobile device.

25. The method of claim 24, wherein the list is periodically updated to the mobile device.

26. The method of claim 20, wherein each comprehensive data set comprises a road speed identifier for one or more road locations wherein the identifier represents a range of speed values.

27. The method of claim 26, wherein each of the identifiers corresponds to a 30 kilometer per hour speed range.

28. The method of claim 26, wherein the range of speed values are represented by different colors on a display of a mobile device.

29. A system for providing traffic data to a mobile device, the system comprising:
a data source for collecting traffic data;
a server receiving traffic data from the data source and utilizing a computer readable medium for encoding a computer program of instructions for executing a computer process of steps including:
a) determining a set of comprehensive traffic data from the traffic data for at least one geographical region at a first time;
b) determining a current set of comprehensive traffic data from the traffic data for the at least one geographical region at a second time;
c) calculating a current differential set of traffic data from a difference between the current set and the first set of comprehensive traffic data;
d) storing the current differential set of traffic data; and
e) repeating operations a, b, c and d for a subsequent current set of comprehensive traffic data operations at a next time; and
one or more mobile devices each communicating with the server for receiving an update set of traffic data to update an existing set of traffic data stored in the mobile device, for the first at least one geographical region wherein the update set of traffic data comprises one or more of the differential data sets of traffic data or one of the sets of comprehensive traffic data.

30. The system of claim 29, wherein the smaller of the one or more differential traffic data sets and the set of comprehensive traffic data is provided to the mobile device.

31. The system of claim 29, wherein the traffic data is periodically obtained from the data source and wherein the traffic data is averaged over at least two periods.
